(19) United States
(12) Patent Application Publication
(10) Pub. No.: US 2021/0148795 A1
(43) Pub. Date: May 20, 2021

(54) DEVICES FOR RAPID SINGLE AND MULTIPLE CELL BLOCKS PREPARATIONS SIMULTANEOUSLY IN VISIBLY LOW CELLULAR SAMPLES

(71) Applicants: Fanny Sharadkumar Desai, Vadodara (IN); Lisam Shanjukumar Singh, Canchipur (IN)

(72) Inventors: Fanny Sharadkumar Desai, Vadodara (IN); Lisam Shanjukumar Singh, Canchipur (IN)

(21) Appl. No.: 17/046,297

(22) PCT Filed: Jul. 11, 2018
(86) PCT No.: PCT/IB2018/055121

§ 371 Date: Oct. 8, 2020

(30) Foreign Application Priority Data
May 27, 2018 (IN) 201821019776

(51) Int. Cl. G01N 1/31; G01N 1/40; G02B 21/34

(52) U.S. Cl. CPC G01N 1/31; G01N 2001/4088; G02B 21/34; G01N 1/4077

(57) ABSTRACT

The present invention provides an apparatus or method for cell block preparation having a protective function, comprising detachable first and second assemblies, test tubes, a strainer, a screw marking, chambers, an aperture, membrane, and the pressure means, wherein first assembly consists of an outer tube and an inner tube and the second assembly consists of three chambers. The outer tube has a screw marking at the lower end which helps to secure a strainer tightly to the second assembly, Wherein the second assembly is made up of three chambers, first part is separated from second part by an aperture; Second part of second assembly is made up of layers of different membranes that are secured under pressure, and third part of second assembly is empty space or reservoir that can collect the excess fluid.

### FIELD OF THE INVENTION

The present inventions relates to a system or method and apparatus for preparing cells for examination of diagnostic samples with visibly low cellularity like FNAC samples, effusion fluids, liquid pap smears, cytology samples collected in fixative like brush cytology, scrapping etc. More particularly, this invention is directed a device that helps to make high quality cell pellet from centrifuged formalin fixed sediments within two minutes with minimal loss of material during processing and section preparation.

### BACKGROUND OF THE INVENTION

cytology means smearing of cells on glass slides, staining with dyes and examination of it. Cytology has many subjective variations and errors in interpretation. It is cumbersome to carry out Immunohistochemistry and molecular testing on cytology smears. Another method of diagnosis is biopsy which is very invasive and sometimes difficult to approach. Cell blocks are intermediate between biopsy and cytology. They are like micro biopsies which are less invasive, cost effective and preserve the morphological architecture thus very useful when lesions are unapproachable for biopsies. Immunohistochemistry and molecular testing can be carried out on Formalin fixed cell blocks. However present methods in preparation of cell blocks are technically difficult and cumbersome.

Furthermore, It is useful for diagnosing or detecting a disease process to perform a histologic or cytologic examination of a tissue cell sample using a light microscope. This requires that a tissue (cellular material) sample must first be retrieved from the patient, and then processed for microscopic examination. A number of minimally invasive techniques are available for retrieving and collecting cell samples from a patient, e.g., by using a fine needle aspiration biopsy, or by brushing body cavity surfaces accessible through minimally invasive endoscopic techniques. A variety of cell sample processing techniques are also known, such as the Cytospin® technique and the Thin-Prep® technique, for depositing cellular materials and tissue fragments directly onto a microscope slide. Another technique, commonly referred to as a cell block preparation, immobilizes cellular materials and/or small tissue fragments within a solid support structure, typically paraffin. Thin sections of the cell block are then cut with a microtome and mounted onto a microscope slide for examination.

There are several approaches in order to minimize the Inevitable loss of diagnostic material during cell block preparation. For example in one approach cell pellets of Sure-Path residues were pre-embedded in ultra-low gelling temperature agarose gel and re-embedded in standard agarose gel. They were fixed, processed, and embedded in paraffin using the same method as tissue sample processing. The resulting agarose cell blocks were trimmed and represented on a CMA for high-throughput analysis using immunocytochemical staining.

Further, there are some cell block techniques are available. For example, Ceilient machine Devices and instruments have been developed like US005137710A where fluid are centrifuged as sediment are deposited in gel matrix activated by chemicals and U.S. Pat. No. 7,914,738B2 where vacuum assisted filtration is used to prepare cell block. EP20130714318 is a device that collect cell in foam while needle aspiration.

Some approach for preparing cell blocks is described by Diaz-Rosario and Kabawat in Cancer, 90:265-272 (2000). In this technique, the cell sample is initially filtered and the filtered sample is scraped from the filter and transferred onto lens paper which is then folded and placed into a tissue cassette and transferred to a tissue processor, followed by steps 6-11 above.

Currently available cell block preparation techniques such as the ones previously described suffer from a number of problems that make them cumbersome, costly, susceptible to contamination or mislabeling, and inefficient for showing diagnostic cells in the final microtome sections. For instance, many of the techniques require that the wax-embedded cell fragments be manually transferred to a tissue cassette required to hold the wax block onto the microtome for sectioning. This manual transfer to the tissue cassette takes a considerable amount of time, as does the step of transferring the cells from a sample tube into a tissue processor. Many of the cell fragments are wasted during the transfer and/or embedding steps. In the past, techniques attempting to improve the concentration of cells within the sectionable material and avoid cell waste have proven less than ideal, because the techniques necessarily involve dilution of the microtome section with carrier substances such that relatively few cells are present, or do not decrease cell loss in pre-embedding steps.

U.S. Pat. No. 7,914,462 describes about a systems and methods for preparing cells for microscopic examination, and more particularly to automated and semi-automated systems and methods for embedding cellular materials and tissue fragments within a paraffin substrate that may be thereafter thinly-cut using a standard microtome, for microscope examination.

Above-mentioned patented systems have not gained widespread acceptance is that such device do not provide high quality cell pellet from centrifuged formalin fixed sediments within two minutes with minimal loss of material during processing and section preparation. Further above mentioned patented and non patent applications that discuss about the device for cell block preparation require any special instruments and infrastructures. Further no prior devices able to handle Multiple samples in short time and easily without work pressure.

All of these stated methods and devices/systems and some other methods and devices/systems presently known in the art have had some flaws in design or mechanism and lacks precision. Most of the existing devices are too expensive to be practical for most users. Some shortfalls of the existing methods and systems include manual interference, leading to inaccuracy in measurements. In light of this, there is a need for a method and system that overcomes these constraints.

The prior art teaches about various Cell block techniques, wherein devices and methods described in prior arts are technically difficult and cumbersome and requires instruments, special centrifuge or technical skill to prepare it. Further Automated system described in prior arts takes 40 minutes to prepare single cell block and multiple sample handlings are difficult with the existing knowledge. However, the prior art does not teach devices and methods that helps to make high quality cell pellet from centrifuged formalin fixed sediments within two minutes with minimal loss of material during processing and section preparation. Further, the prior arts do not teach about any devices and methods that does not require any special instruments and infrastructures. Further, no prior art teaches about handling of Multiple samples in short time easily without work pressure.

Further the present invention does not require any special instruments and it requires no centrifugation once the formalin fixed samples sediments are made. Cell block preparation by our device is operator independent, easy and fast. It helps to make high quality cell pellet from centrifuged formalin fixed sediments within two minutes with minimal loss of material during processing and section preparation. Any routine histopathology and cytology lab without any added equipments can use this device.

Despite the aforesaid drawbacks, there exists a need to provide a device that create high quality cell pellet from centrifuged formalin fixed sediments within two minutes with minimal loss of material during processing and section preparation, wherein the device does not require any special instruments and infrastructures and also handled Multiple samples easily without work pressure.

Until now no one has ever devised a device that make high quality cell pellet from centrifuged formalin fixed sediments within two minutes with minimal loss of material during processing and section preparation. Further, able to handled Multiple samples in short time easily without work pressure.

The present invention addresses the issues as discussed above.

### SUMMARY OF THE PRESENT INVENTION

An object of the present invention is to provide a device and method for preparations of Rapid single and multiple cell blocks simultaneously in visibly low cellular samples.

The present invention overcomes the disadvantages discussed above by providing a device and method for cell preparation for examination of diagnostic samples with visibly low cellularity like FNAC samples, effusion fluids, liquid pap smears, cytology samples collected in fixative like brush cytology, scrapping etc.

Another object of the present invention to provide a device and method to make high quality cell pellet that is cost effective and preserve the morphological architecture.

Another object of the present invention to provide a device and method that helps to make high quality cell block from centrifuged formalin fixed sediments within two minutes.

Another object of the present invention to provide a device and method that helps to make high quality cell block with minimal loss of material during processing and section preparation.

Another object of the present invention to provide a device and method to make high quality cell block without any special requirement of any special instruments, special centrifuge or technical skill and infrastructures.

Another object of the present invention to provide a device and method that handles multiple samples in short time easily without work pressure.

Another object of the present invention to provide a device and method to make high quality cell block Cell blocks, wherein the preparation of cell block by invented device is operator independent, easy and fast.

The details of one or more implementations are set forth in the accompanying description below. Other aspects, features and advantages of the subject matter disclosed herein will be apparent from the description and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The following figure depicts certain illustrative embodiment of the invention. This depicted embodiment is to be understood as illustrative of the invention and not as limiting in any way.

Referring particularly to the drawing for the purpose of illustration only and not limitation, there is illustrated:

FIG. 1 shows components of a cell block manufacturing apparatus of the present embodiment of the invention;

FIG. 2 shows a schematic view of cell block manufacturing apparatus of the present embodiment of the invention;

FIG. 3 is a detailed view of another embodiment of a cell block apparatus of the present invention;

FIG. 4 is a detailed view of another embodiment of a cell block apparatus of the present invention.

### DETAILED DESCRIPTION OF THE INVENTION

As required, an exemplary-only embodiment of the present application is disclosed herein; however, it is to be understood that the disclosed embodiment is merely exemplary of the present disclosure, which may be embodied in various and/or alternative forms. Specific process details disclosed herein are not to be interpreted as limiting, but merely as a basis for the claims and as a representative basis for teaching one skilled in the art to variously employ the present disclosure in virtually any appropriately detailed processes.

Aspects, advantages and/or other features of the exemplary embodiment of the disclosure will become apparent in view of the following detailed description, which discloses various non-limiting embodiments of the invention. In describing exemplary embodiments, specific terminology is employed for the sake of clarity. However, the embodiments are not intended to be limited to this specific terminology. It is to be understood that each specific portion includes all technical equivalents that operate in a similar manner to accomplish a similar purpose.

Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures. The invention will be more clearly understood from the following description of the product thereof.

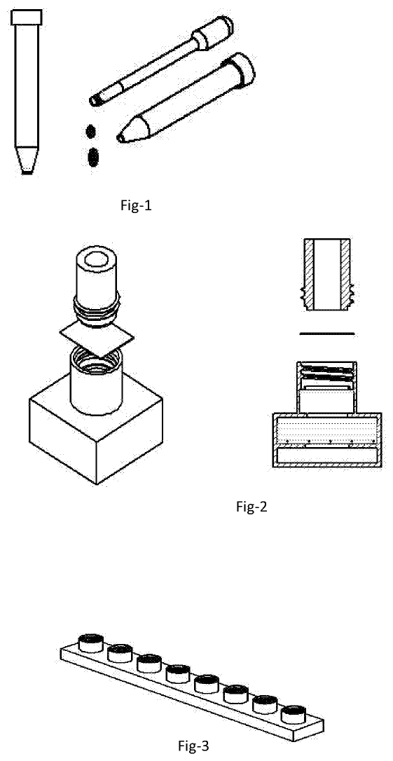

Reference is now made to the drawings wherein like numbers refer to like elements throughout. FIG. 1 and FIG. 2 illustrates shows a schematic view of cell block manufacturing apparatus and component as according to the present invention, with which the improved apparatus and method of the present invention is intended to be used. It is to be understood, however, that the precise configuration of the improved system is not a limitation of the present invention and could assume any number of sizes and layouts. The septic system shown is for illustration purposes only.

The following describes a device for cell block preparation, wherein the device for cell block preparation comprises, an outer tube, an inner tube, a strainer.

The present invention is directed to an improved device that helps to make high quality cell pellet from centrifuged formalin fixed sediments within two minutes with minimal loss of material during processing and section preparation. Further the device does not require any special instruments and infrastructures and also able to handle multiple samples in short time easily without work pressure.

Reference is now made to FIG. 1. and FIG. 2, The drawing shows, a device, wherein the device is made up of two detachable assemblies. Assembly one consists of outer tube and inner tube. The outer tube has screw marking at the lower end which helps to secure strainer tightly to second assembly. The inner tube is of 3-4 ml capacity with different diameters based on particle size in sediment. Strainer is inert cloth or a thin filter with variable pore sizes based on size of cell particles, wherein the strainer size prefer 50 micron and 100 micron pore size. Second assembly is made up of three chambers, wherein an Upper most part has screw markings and the space where bottom of the first assembly with strainer can be secured tightly. The first part is separated from second part by an aperture, wherein the aperture in second assembly is smaller than the diameter of inner tube of first assembly. Further, Second part of second assembly is made up of layers of different membranes that are secured under pressure. The first layer is made up of wicking material that carries the excess fluid by capillary forces in lower layers. It does not absorb the fluid. Second layers are made up of wicking and partially absorbing material which absorb the fluid and spread horizontally as well as shift the fluid further to lower layers. We used stacking of tissue papers. Third layer is made up of superabsorbent powder, wherein the superabsorbent powder can be wood husk or sodium polyacrylate or any organic material that absorb fluids. We used sodium polyacrylate. Underneath is the layer of adhesive on a membrane which secured the superabsorbent powder. The membrane can be a cardboard or filter paper. The last layer is the wicking and absorbent material. The wicking material can be a cloth or a fabric that can carry the fluid in lower chamber. Third part of second assembly is empty space or reservoir that can collect the excess fluid in few cases.

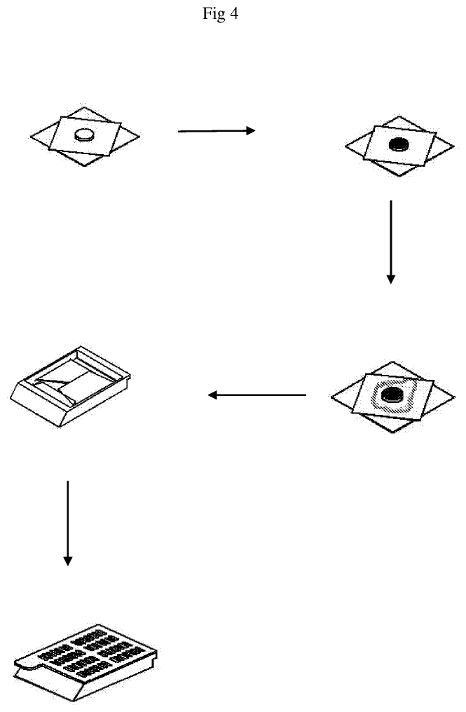

Reference is now made to FIG. 3. and FIG. 4, The drawing shows, a device, wherein the device can be used as a single unit or as part of large device with multiple units.

In operation, the device comprises a First and a second assembly, wherein the First and the second assemblies, are fitted together with strainer in the middle. Once the sediment is prepared in conical tube, it is aspirated using special pipette which has end that has diameter that of bottom of conical tube. Aspirated sediment, approximately 1 ml is poured in inner tube of the device. Conical tube is rinsed with fixative and same is poured in inner tube. After 1-2 minutes the cell particles found to be aggregated on strainer. A drop of eosin is put on cell pellet. The strainer is detached and laid flat on filter paper. Partially melted gel-2% agar medium is applied on cell pellet. Once it sets the strainer and tissue paper is wrapped and put in cassettes and processed as routine biopsy specimen.

The invention has several advantages. With this invented device for cell block preparation, the device is operator independent, easy and fast and also able to handle multiple samples in short time easily without work pressure.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in composition, materials, form, function and manner of operation, and use, are deemed readily apparent and obvious to one skilled in the art, and all equivalent relationships to those illustrated in the drawings and described in the specification are intended to be encompassed by the present invention.

While in the foregoing specification, several embodiments of the invention have been set forth for purposes of making a complete disclosure, it will be apparent to those skilled in the art that numerous changes may be made without departing from the spirit and principles of the invention.

Therefore, the foregoing is considered as illustrative only of the principles of the invention. Further, since numerous modifications and changes will readily occur to those skilled in the art, it is not desired to limit the invention to the exact construction shown and described, and accordingly, all suitable modifications and equivalents may be resorted to, falling within the scope of the invention.

We claim:

1. A cell block preparation apparatus, comprising:
detachable first and second assemblies, wherein first assembly consists of an outer tube and an inner tube and the second assembly consists of three chambers;
The outer tube has a screw marking at the lower end which helps to secure a strainer tightly to the second assembly,
Wherein, the second assembly is made up of three chambers, first part is separated from second part by an aperture; Second part of second assembly is made up of layers of different membranes that are secured under pressure, and third part of second assembly is empty space or reservoir that can collect the excess fluid.

2. The cell block preparation apparatus of claim 1, wherein the strainer is an inert cloth or a thin filter with variable pore sizes based on size of cell particles.

3. The cell block preparation apparatus of claim 1, wherein the pore sizes of strainer is in between 50 micron and 100 micron pore size.

4. The cell block preparation apparatus of claim 1, wherein the inner tube is of 3-4 ml capacity with different diameters based on particle size.

5. The cell block preparation apparatus of claim 1, wherein aperture in second assembly is smaller than the diameter of inner tube of first assembly.

6. An method for preparation of a cell block, the method comprising:
First and second assemblies are fitted together with a strainer in the middle;
preparing a sediment in a conical tube and aspirated using special pipette;
pouring approximately 1 ml of the Aspirated sediment in an inner tube of a device.
aggregating cell particles found on the strainer after 1-2 minutes;
putting a drop of eosin on cell pellet and also a partially melted 2% agar medium is applied on cell pellet.
